(19) United States
(12) Patent Application Publication
(10) Pub. No.: US 2012/0222457 A1
(43) Pub. Date: Sep. 6, 2012

(54) RESTRAINT SYSTEMS AND METHODS

(76) Inventors: Matthew Kriesel, Melrose, WI (US); Troy Goodenough, Mindoro, WI (US)

(21) Appl. No.: 13/315,043

(22) Filed: Dec. 8, 2011

Related U.S. Application Data
(60) Provisional application No. 61/420,963, filed on Dec. 8, 2010.

(51) Int. Cl. E05B 75/00

(52) U.S. Cl. 70/16

(57) ABSTRACT

A restraint system includes: a base system engages a restraint to apply the restraint to a person, for example, on the limbs of a person. The base system can communicate with a remote control operated by security person. The remote control can be from a remote location so that the security person is removed from intimate contact with the person to be restrained. This can increase the safety form the security person. The base system can be fixed to a portion of a vehicle, such as a roof, trunk, side panel, hood, bumper, etc. The restraint can include a locking mechanism that helps to prevent overtightening.

### RELATED APPLICATION

This application claims priority under 35 U.S.C. §119(e) to U.S. Provisional Patent Application No. 61/420,963, filed Dec. 8, 2010, which is incorporated herein by reference in its entirety.

### FIELD OF THE INVENTION

The present inventions relate to restraint systems, devices and methods.

### BACKGROUND

Police, military and security personnel are tasked with protecting the public while placing themselves at risk. Handcuffs are used to control suspects and those that may pose a danger. Metal handcuffs provide secure restraints. Plastic handcuffs are also used. Examples of such handcuffs can be found in U.S. Pat. Nos. 5,193,254; 5,463,884; 5,680,781; 5,099,662; 7,284,399; 6,978,644; 6,615,622; 6,334,444; and 6,240,602, each of which is incorporated herein by reference for any purpose. However, if there is a conflict between the present disclosure and the incorporated documents, then the present document controls interpretation.

### BRIEF DESCRIPTION OF THE DRAWINGS

FIG. 1 illustrates a schematic view of restraint system, according to an example embodiment.

FIG. 2 illustrates a side view of a restraint system, according to an example embodiment.

FIG. 3 illustrates an elevational view of restraint system, according to an example embodiment.

FIG. 4 illustrates a perspective, front view of a restraint system, according to an example embodiment.

FIG. 5 illustrates a perspective, rear view of a restraint system, according to an example embodiment.

FIG. 6 illustrates a perspective, cutaway view of a restraint system, according to an example embodiment.

FIG. 7 illustrates a perspective, cutaway view of a restraint system, according to an example embodiment.

FIG. 8 is a schematic view of restraint system, according to an example embodiment.

FIG. 9 is an exploded view of a restraint, according to an example embodiment.

FIG. 10 is an exploded view of a latching mechanism for a restraint, according to an example embodiment.

FIG. 11 is a partially assembled view of a latching mechanism for a restraint, according to an example embodiment.

FIG. 12A is a plan view of an end portion of a restraint, according to an example embodiment.

FIG. 12B is a cross sectional view of taken generally along line 12B of FIG. 12A, according to an example embodiment.

FIG. 13 is a plan view of an end portion of a restraint, according to an example embodiment.

FIG. 14 is a cross-sectional view of a restraint taken generally along line 14-14 of FIG. 13, according to an example embodiment.

FIG. 15 is a view of a lock body of a restraint, according to an example embodiment.

FIG. 16 is a flow chart of a method for applying a restraint, according to an example embodiment.

FIG. 17 is a schematic view of a remote control device, according to an example embodiment.

FIG. 18 illustrates an elevational view of restraint system, according to an example embodiment.

FIG. 19 illustrates a view of a restraint, according to an example embodiment.

FIG. 20 illustrates a cross-sectional view of a restraint system, utilizing a cable and release mechanism.

FIG. 21 illustrates a cross-sectional view of a restraint system, utilizing a cable and removable cartridge.

All Figures are illustrated for ease of explanation of the basic teachings of the present invention only; the extensions of the Figures with respect to number, position, relationship and dimensions of the parts to form the preferred embodiment will be explained or will be within the skill of the art after the following description has been read and understood. Further, the exact dimensions and dimensional proportions to conform to specific force, weight, strength, and similar requirements for various applications will likewise be within the skill of the art after the following description has been read and understood. Where used in various Figures of the drawings, the same numerals designate the same or similar parts.

### DETAILED DESCRIPTION

The figures generally illustrate exemplary embodiments of the restraint system or components thereof. Also illustrated are methods for implementing aspects of the restraint system. These illustrated embodiments are not meant to limit the scope of coverage but, instead, to assist in understanding the context of the language used in this specification and in the appended claims. Accordingly, the appended claims may encompass variations of restraint system and methods for using the restraint system that differ from the exact language of the illustrated embodiments.

It will be understood that directional terms refer to the orientations to the drawings or are relative to other components of the structure being described. This convention is adopted for ease of understanding.

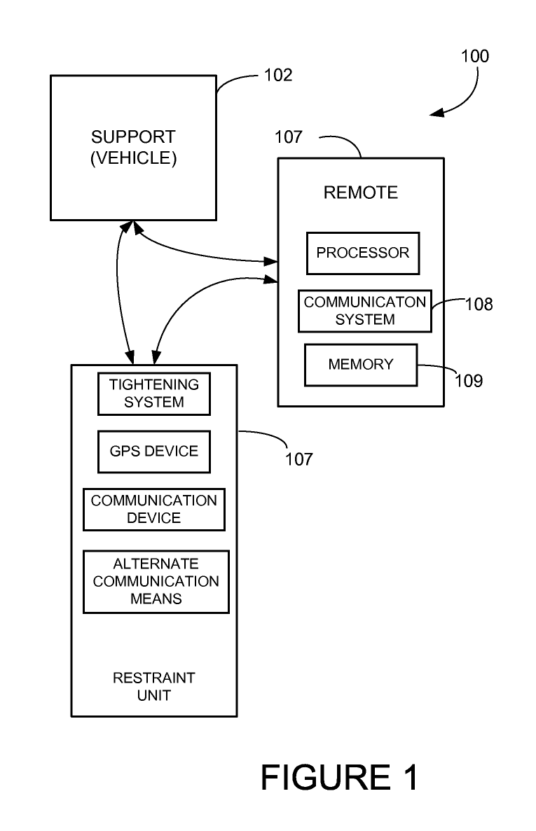

FIG. 1 illustrates a restraint system 100 that includes a support 102 on which a restraint unit 105 can be mounted. A remote control device 107 can communicate with the support 102, the restraint system 105 or both. The remote control device 107 is portable and can easily be carried by a security person. The support 102 can be a solid structure such as a countertop in a booking room or a mobile device that can be moved where it is needed, e.g. a cart or other wheeled structure. The support can also be a motor vehicle that transports security personnel, police, military personnel, or prison guards. Examples of vehicles include automobiles, squad cars, trucks, personnel carriers, boats, personal transport vehicles, e.g., Segways™, and human powered vehicles. The restraint unit 105 can be fixed to a part of the support 102, which can be accessed by the security personnel and the persons-to-be-restrained (at times herein, “suspect”). The restraint unit 105 is to allow the security person to restrain a suspect without being in close proximity to the suspect. Close proximity can be variously defined as within the reach of the suspect, within striking distance of the suspect, within reach or striking distance of a group of suspects, or, generally within a zone of danger. To this end, remote control device 107 can wirelessly communicate with the restraint system 105 to activate and deactivate the restraint unit 105. The remote control device 107 can further communicate with the support 102 to control various operations of the support, e.g., lock doors of a vehicle, change settings of the emergency light system, activate recording devices, activate safety features, or other operations of a security vehicle.

The remote control device 107 can communicate with either the support 102 or the restraint base unit 105 by a bidirectional data communication link which transmits coded data between the remote control device and at least one of the support 102 or the restraint base unit 105. The coded data can be generated by a symmetrical coding method using secret coding information stored in the remote control device 107 or in the electronics of the support or in electronics of the base restraint unit 105. The remote control device can have a secret coding information learn mode. When this learn mode is activated in the remote, the remote control device 107 emits a learn mode reporting signal. Either the support 102 or the restraint unit base 105 upon the receipt of the learn mode reporting signal from the remote device 107, a learn mode acknowledgment signal is sent. Once the learn mode acknowledgment signal is received by the remote control device, it activates the coding algorithm stored in its memory, e.g., a symmetrical coding method, as a function of secret coding information previously stored in memory of the remote control device. The algorithm determines new secret coding information and sends the new secret coding information to either the support or the restraint unit base, or both. The restraint base or the vehicle of both, after the receipt of the new secret coding information, replaces the previously stored secret coding information with the new one. An update successful signal is then sent to the remote control device. Thereafter, the remote control device replaces the previously stored secret coding information with the new secret coding information. The remote control device 107 can control at least one vehicle-side function unit other than the restraining function of the restrain unit. Vehicle-side functions may include such operations as starting or shutting off a vehicle, operating door locks, controlling light bar or vehicle lights, etc. Each function of the remote control device 107 can use separate secret coding information for each function. Each of these separate functions can communicate via a different secret coding information specifically assigned to respective communication frequency channels. Such secret coding information is desirable in the security field to prevent a suspect or cohort from operating the restraint system improperly.

The support 102, such as a vehicle, can send lockout signals to the restraint unit and render the restraint unit 105 unusable if certain dangerous conditions exist. For example, if the transmission of the vehicle 102 is not in park, then vehicle sends a lockout signal to the restraint unit 105. Other signals that can lockout the restraint unit 105 from use include starting the engine, a security code to prevent theft of the vehicle, etc.

The restraint unit 105 further includes an accelerometer that senses movement of the restraint base unit 105. The accelerometer measures proper acceleration it experiences relative to freefall. The accelerometer can measure acceleration in a single-axis or in a multi-axis frame. The accelerometer can further detect magnitude and direction of the acceleration. In an example, the accelerometer is a micro-machined electro-mechanical (MEMs) accelerometers. One example is a cantilevered beam MEMs accelerometer, which includes a proof mass on the cantilever. Under the influence of external accelerations the proof mass deflects from its neutral position. This deflection can be measured in an analog or digital manner. In an example, capacitance between a set of fixed beams and a set of beams attached to the proof mass is measured. In another example, piezoresistors can be integrated in the springs to detect spring deformation. If the measured acceleration is outside a safe measurement, then the accelerometer issues a signal to the processor or directly to a safety module that releases the restraint from the restraint base unit.

In operation, a support 102 arrives at an incident where a suspect needs to be restrained. The security officer instructs the suspect to approach the restraint unit 105. The security officer instructs the suspect to place their arms into restraints (embodiments are described in greater detail hereafter) that are on the restraint unit 105. The security officer uses the remote control device 107 to instruct the restraint unit to activate the restraints. The suspect would then be restrained to the restraint unit 105, which can be fixed to the support 102. At this time, it is safer for the security officer to approach the restrained suspect to conduct a body search (sometimes referred to as a frisk or a patdown), for example, for weapons, drugs and stolen property. Other methods as described herein can be included in this methodology.

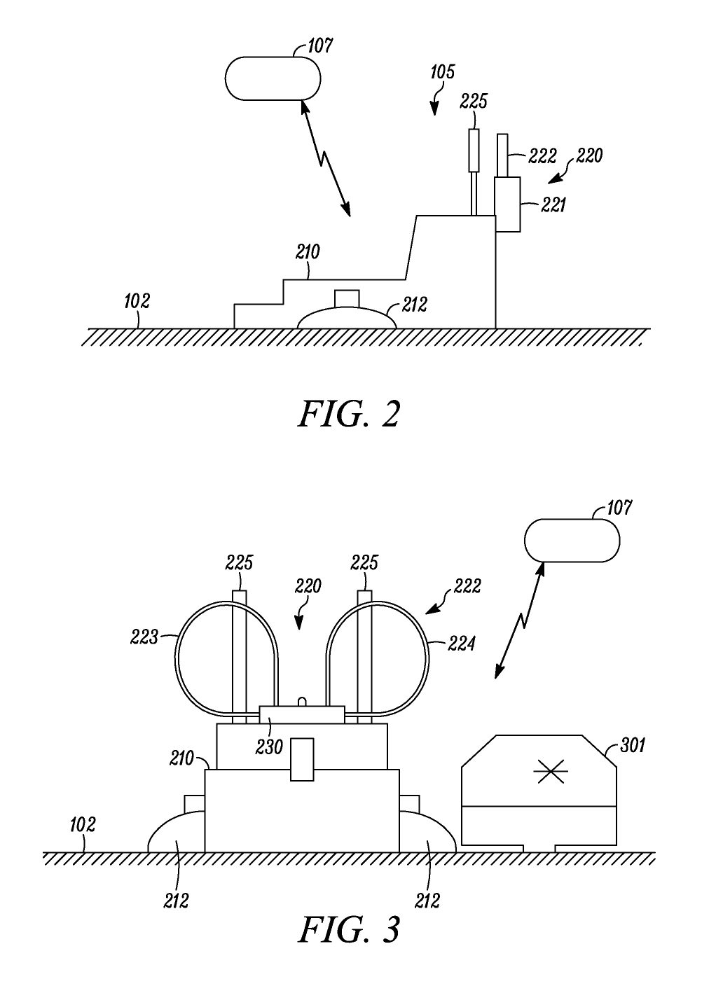

FIGS. 2 and 3 illustrate a side view and front view of the system 100 with the restraint unit 105 fixed to the support 102. The restraint unit 105 can be fixed to a side of a security vehicle, e.g., on the roof of an automobile, on a trunk, on a hood, or on a quarter panel. The remote control device 107 can wirelessly communicate with the restraint unit 105. Restraint unit 105 includes a base 210 that encloses all moving parts and electronic parts of the restraint unit. Base 210 further prevents tampering with the moving and electronic parts to prevent a suspect from interfering with the operation of the restraint system. Base 210 weatherproofs these same parts such that the restraint system can be used outside in the elements. A fixture 212 fixes the base 210 to the support 102, for example, by fasteners, such as bolts, or by welding. In an embodiment, a fixture 212 is placed on each side of the base 210. The fixture 212 can be permanently fixed to the support 102 with the housing removably attached to the fixture 212.

A restraint assembly 220 is connected to the base 210 and is operatable by the parts in the base 210. Restraint assembly 220 includes a base 221 and restraint 222 connected to the base. The base 221 connects to the housing. The restraint 222 forms loops 223, 224 into which the suspect respectively inserts their limb so that either the wrist or ankle is generally aligned with the loops 223, 224. Grips 225 extend upwardly from the base 210 and are aligned with the apertures defined by the restraint 222. In use, the suspect reaches through the loops 223, 224, which define apertures, and grips the respective grip 225. In an embodiment, the grips 225 include an activation switch that activates the restraint unit when the suspects hold the grips 225. Such a switch can assist in preventing unwanted activation of the restraint system. Once the suspect holds the grips 225 with their hand and their arm extending through the loops 223, 224, the security person can activate the restraint system to tighten the loops 223, 224 around the wrist or arm of the suspect. The loops 223, 224 are connected together through a rigid base 230 to form a dual handcuff. If the present restraint to be used on the ankles of a suspect, then the base 230 can include links or is flexible to allow a user to walk.

FIG. 3 further shows a light bar 301 mounted to the support 102, which can be a roof of a vehicle in this embodiment. The restraint unit 105 is mounted to the roof adjacent the light bar 301. The remote control device 107 can wirelessly control the restraint unit 105 as well as the light bar 301 to deactivate the lights adjacent the restraint unit when approached by a suspect or while securing a suspect.

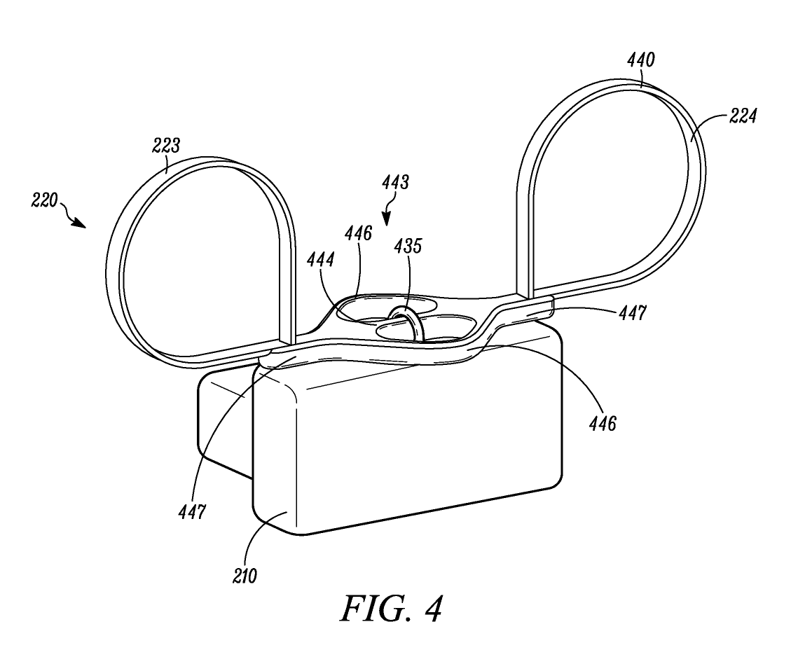

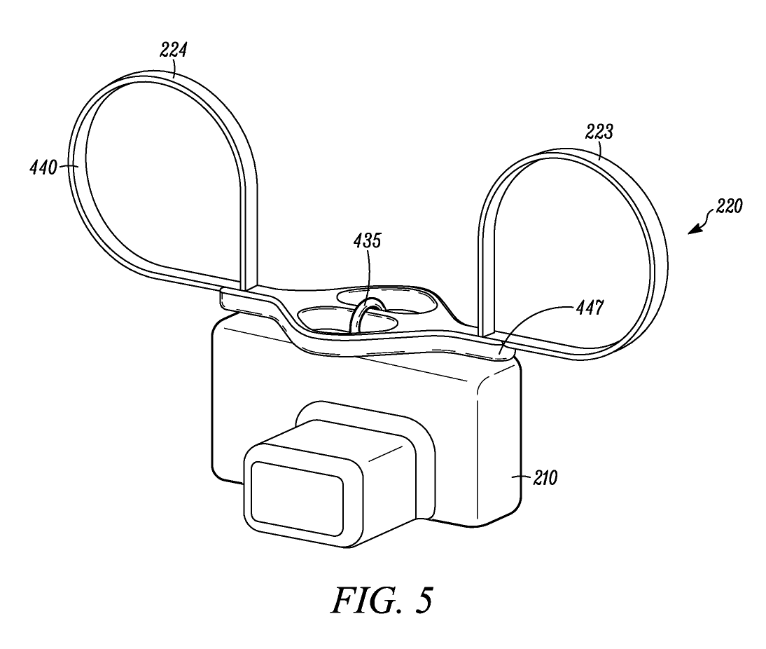

FIGS. 4 and 5 illustrate a schematic, perspective front view and a schematic, perspective front view of a restraint unit 100 including base 210 on which restraint assembly 220 is fixed. Restraint assembly 220 includes strap 440 of flexible polymer, for example, a nylon or other long chain polymer that extends through a restraint intermediate base 442. Intermediate base 442 is a rigid base that is connected to the restraint system base 210. Intermediate base 442 includes a central portion 443 that includes a central longitudinal extension 444 through which the strap 440 can extend and lateral extensions 446 that are bowed outwardly from the central longitudinal extension portion 444 to form apertures intermediate the central longitudinal extension 444. These apertures allow a person to grip the restraint base 442 to insert the restraint assembly 220 onto the restraint system base 210 or to grip the restraint 220 to assist in controlling or guiding the restrained suspect. A releasable latch 435 connects the restraint assembly 220 to the restraining system base 210. In an example, the latch 435 extends through the apertures and over the central extension 444 to releasably connect the restraint assembly 220 to the base 210. End extensions 447 extend outwardly from the central portion 443 and can be generally aligned with the central portion 443. In an embodiment, the strap 440 is a single unitary length. In an embodiment, the strap 440 is divided into two pieces that are fixed at one end to the base and extend outwardly of the base 442. Free ends of the strap 440 are threaded back into the base 442 and received in the restraining system base 210 to form loops 223, 224. In an embodiment, the strap 440 includes apertures that align with apertures in the end extensions 447 so that free ends of the strap 440 can be fed through the extensions 447 and through a portion of the strap into the body of the restraining system base 210. By feeding the strap back through itself, the strap 440 is fixed in place on the restraint base 442. This will help prevent a suspect from moving the strap 440 prior to tightening so that misuse of the restraint system 100 is reduced.

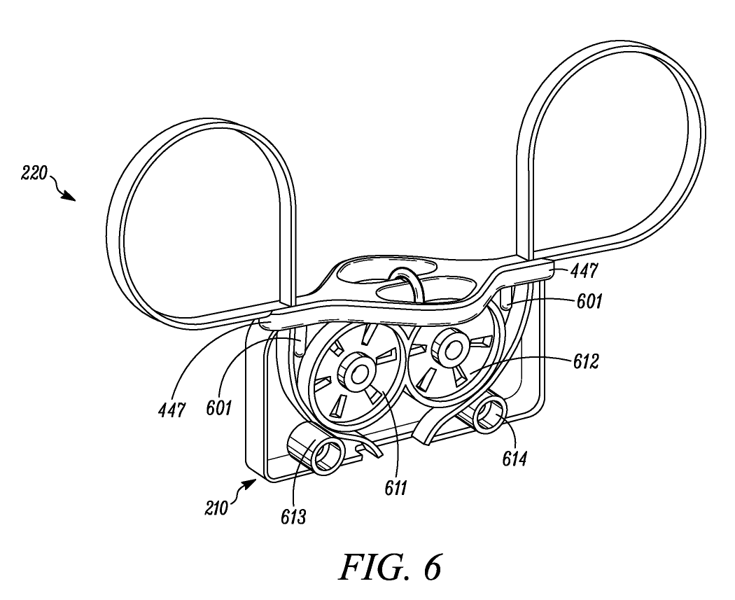

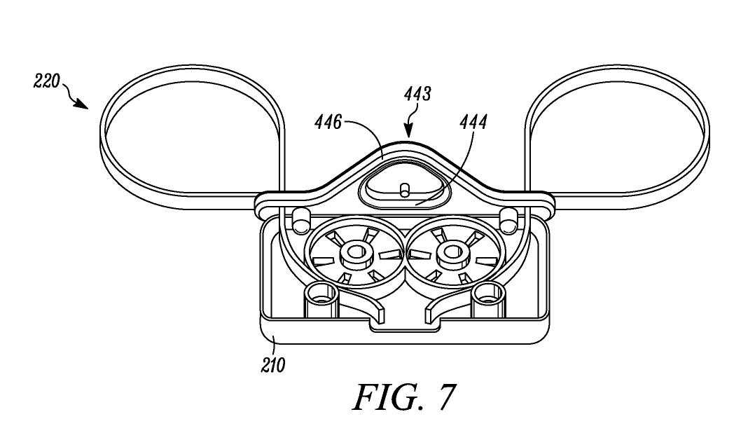

FIGS. 6 and 7 illustrate schematic, partial cutaway views of a restraint unit 100 including base 210 on which restraint assembly 220 is fixed. Features that are the same as those described with reference to FIGS. 4 and 5 are not repeated here. Mounting pegs 601 extend downwardly from the extensions 447 of the restraint base 442 and are received in detents or aperture in the top face of the base 210. The pegs correctly position the restraint assembly 220 on the base 210 while feeding the free ends of the strap into the base to engage a tightening system in the base 210. In a further embodiment, a locking mechanism engages the pegs 601 to releasably fix the restraint assembly 220 to the base 210. Free ends of the restraint strap 440 extend into the interior of restraint unit base 210 past and between tightening reels 611, 612 and guide posts 612, 614. In operation, the reels 611, 612 engage the free end portions of the strap 440 to tighten the restraint strap 440 around the suspect's limb inserted in the loop. Stated another way, the loops are made smaller by the reels 611, 612 pulling the strap free end portions. In an example, the reels 611, 612 are driven by a motor that does not have sufficient power to tighten the loops to hurt a suspect but with enough force to sufficiently restrain the suspect. In an example, the reels 611, 612 are driven by a spring that causes the reels or other strap engagement device to engage the straps and quickly tighten the loop(s) of the strap(s). A motor can be provided to bias the springs. In another example, the springs can by manually biased by a manual crank or wheel that can be wound outside the housing of the base. After the loops 223, 224 are tightened on the suspect's wrists or ankles, the latching mechanism 435 or a locking mechanism can release the restraint assembly 220 so that the suspect can be further processed or a further restrain assembly 220 can be mounted to the restraint system base for the next suspect.

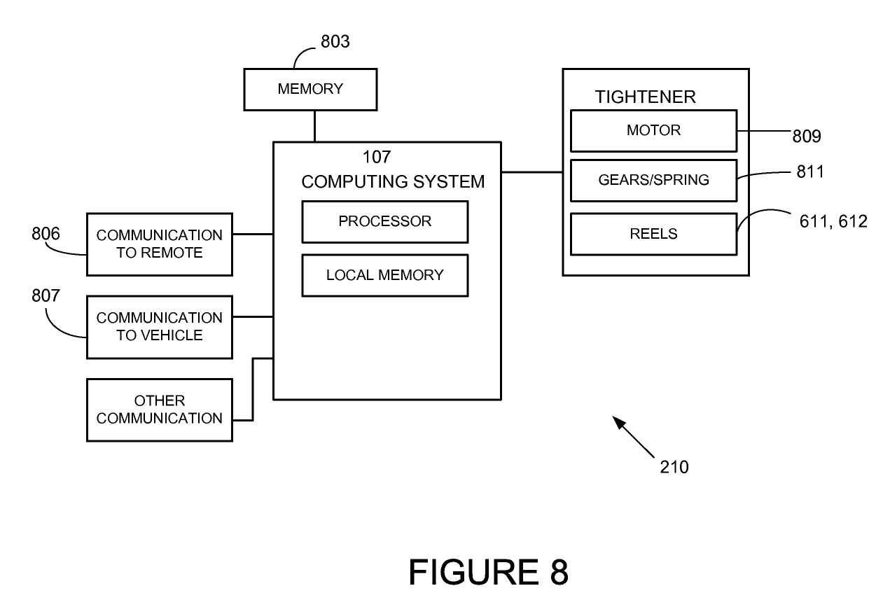

FIG. 8 illustrates a schematic view of a restraint system base 210, which includes a controller 801 that can control operation of the restraint system base. Controller 801 is in communication with a memory 803, which can include permanent memory such as nonvolatile memory and random access memory for use during processing by the controller. The controller 801 includes a processor that reads programs, i.e., machine instructions, from memory 803 during a boot up process. Certain bios instructions can be stored at a fixed location to begin a startup program. In a further example, the controller 801 includes a programmable logic array that can control operation. A first communication device 806, which can include electrical circuits and an antenna or an input/output port, is adapted to communicate with the remote control device. The remote communication device 806 receives remote or wireless instruction signals from the remote control device and passes these signals to the controller 801. A second communication device 807, which can include electrical circuits and an antenna or an input/output port, is adapted to communicate with devices outside the restraint unit. In an example, the second communication device 807 can communicate with electronic devices in the vehicle on which the restraint unit 105 is mounted. The second communication device 807 can send and receive signals with communications systems in the vehicle or with remote computer systems.

In an example, the second communication device 807 can provide interaction with the restraint unit and/or the security officer using the restraint device. Devices in a vehicle or that can communicate with the restraint unit 105 device can include a computer having a display device, such as a touch screen, for displaying information to the user, a keyboard, a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input. The second communication system 807 can send signals to and from the video recording system in a security vehicle. The methods and apparatus described and contemplated herein can communicate with a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet. The computing system may include clients and servers. A client and server are generally remote from each other and typically interact through a communication network. The relationship of client and server arises by virtue of computer programs running on the respective computers and having a client-server relationship to each other.

The controller 801, when executing instructions that are stored in its memory, is to control operation of a motor 809 that is connected to the reels 611, 612 or to springs through gears 811. In an example, the motor is directly connected to one of the reels 611, 612 and the other reel is driven by the first reel. The controller 801 receives an activation signal from the remote control device 107 through the first communication system 806. The controller 801, if there are no overriding stop signals or flags stored in the controller or memory 803, activates the motor 809. The motor 809 turns the reels 611, 612, which in turn, pulls the free ends of the restraint strap to close the loops around the suspect's wrists. In an example, the reels 611, 612 rely on friction to engage the strap. In an example, apertures are in the strap and the reels include teeth that engage the strap apertures to shrink the loops in the restraint strap. In an example, the restraint assembly 220 is attached to the restraint unit 105, which is attached to the support 102, when the suspect is restrained in the restraint unit 105.

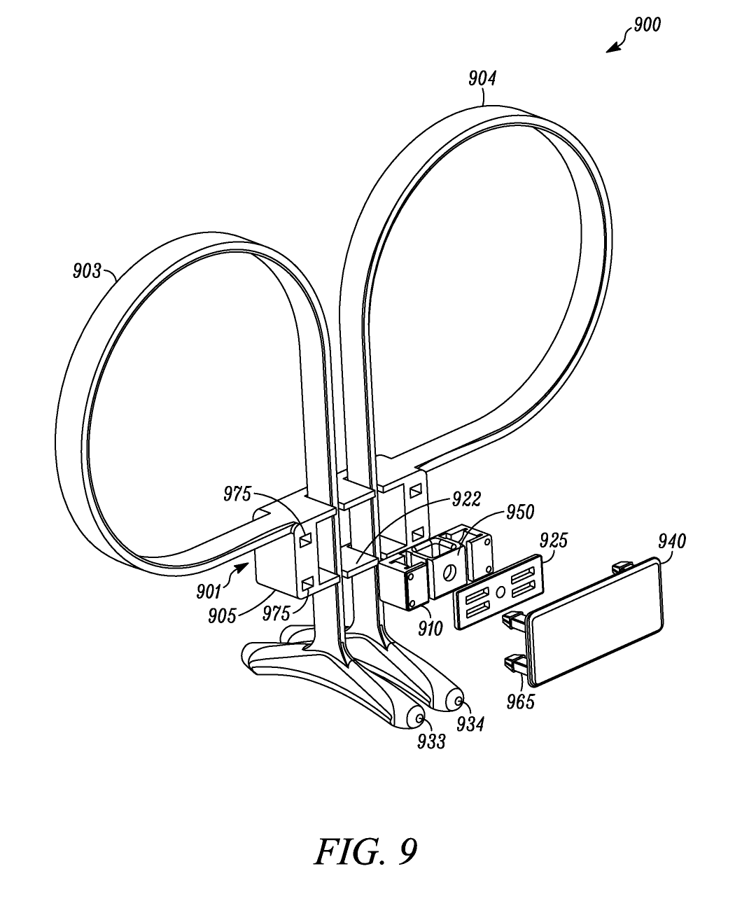

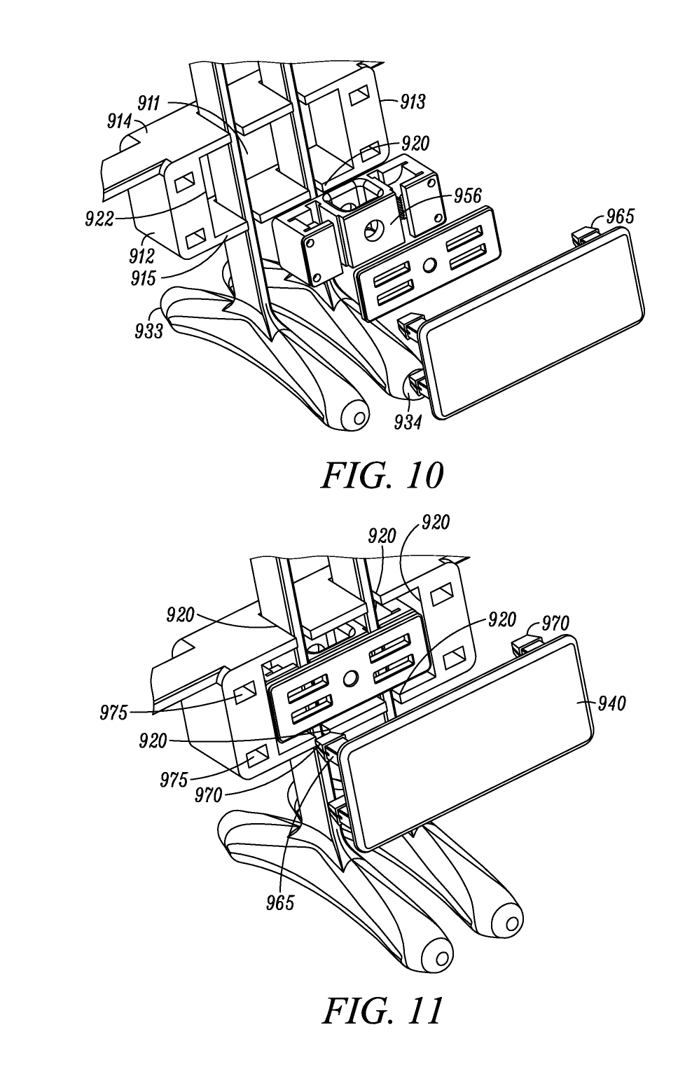

FIGS. 9-11 illustrate a restraint assembly 900 that is designed to secure an individual's wrists or ankles close together. Restraint assembly 900 is adapted to be used in the restraint unit 105 described herein or as a standalone restraint device. Restraint assembly 900 includes a coupling 901 that couples two straps 903, 904 together. The restraint assembly 900 further includes a latching mechanism. The straps 903, 904 form the restraints that secure an individual's limbs.

The coupling 901 includes an outer body 905, an inner body 910, a plate 925, and an outer cover 940. The outer body 905 has a box shape and includes a rear wall 911, a left end wall 912, a right end wall 913, a top wall 914 and a bottom wall 915. Each of these walls can be integrally formed from a polymer of sufficient strength to resist attempted damage by a person being restrained. The straps 903, 904 can also be integrally formed with the coupling 901, as shown extending from the left and right end walls 912, 913, respectively. At least for walls are solid to provide for a secure coupling. In an example, at least two walls are essentially solid. Solid and essentially solid are defined to be of sufficient strength to prevent a person from damaging the coupling to such an extent that the restraint would fail. A front wall 917 of the coupling 901 is essentially open except near the left and right end walls 912, 913. The walls 911-915 essentially define an open sided rectangular prism. In a further example, the end walls 912, 913 are formed to a greater thickness than the other walls. Recesses 918 are formed in these ends walls 912, 913. Slots 920 are formed in the top wall 914 and the bottom wall 915. Slots 920 in the top wall 914 are vertically aligned with slots 920 in the bottom wall 913. The walls 911-915 define an open interior 922.

The straps 903, 904 are elongate and extend from respective ends of the coupling 901. The straps 903, 904 extend outwardly from the coupling 901. In an example, the straps 903, 904 are cantilevered from the left and right sides 912, 913 of the coupling 901. In the illustrated example, the straps extend from adjacent the top wall 914. In an example, the straps have a length in a range of about 26 inches to about 36 inches and a width in a range of about ¼ inch to about ¾ inch. In an example, the each strap 903, 904 can have a length of about 30 inches and a width of about ½ inch. The strap 903, 904 can be formed from nylon and have a tensile strength of at least 400 lbs. The edges of the straps 903, 904 are beveled for comfort of use, e.g., gripping by an assembler, use by a security person, and wear by a secured person, and to reduce likelihood of damage to the strap 903 or 904 or the coupling 901. The straps 903, 904 are looped from the coupling such that the flat sides of the straps are on the inside loop. The straps 903, 904 thread through an aligned pair of the slots 920 so that the straps create loops that can receive a suspect's limbs, respectively. The left strap 903 creates a left loop that extends through the vertically aligned left slots 920 in the top and bottom walls. A handle 933, 934 is at the free end of each of the strap 903, 904, respectively. Handles 933, 934 can be gripped by a person's hand to tighten the strap loops. The handles 933, 934 further act as stops to prevent the strap 903 or 904 from being removed from the coupling 901. Portions of the straps 903, 904 include ratchets or detents. In an example, the ratchets are positioned on the strap side interior to the loop. In an example, the straps 903, 904 include apertures in addition to or in place of the ratchets or detents.

Inner body 910 defines a rectangle prism that includes a rear wall 941, a left end wall 942, a right end wall 943, and a front wall 945. A center structure 950 extends from the rear wall 941 and defines part of the front wall 945. The center structure 950 includes a left side wall 951, a right side wall 952, and a front wall 953. The top and bottom of the center structure 950 are open. The left side wall 951 is generally aligned an inner edge of the left slot 922 in the outer body 905. The right side wall 952 is generally aligned an inner edge of the right slot 922 in the outer body 905. The walls 941, 942, 943, and 945 have a height less than the height of the inner volume 922 of the outer body 905. In an example, the entire inner body 910 has a height less than the height of the inner volume 922 of the outer body 905. Open slots 958 are in the front wall of the inner body 910. The slots 958 run the entire height of the inner body and have a width about the same as the width of the strap 903, 904. In an example, the slot 958 has a width slightly larger than the width of the strap 903, 904. Within the volume defined by the left side wall 942, rear wall 941, and front wall 945, a left latch is provided. The left latch can be a pawl to engage the ratchet of the strap 903. Within the volume defined by the right side wall 942, rear wall 941, and front wall 945, a right latch is provided. The right latch can be a pawl to engage the ratchet of the strap 903. In an example, the left and right latches are mirror images of each other. The latches can flex when the strap moves downwardly in the coupling and does not flex if the strap attempts to move upwardly in the coupling.

Plate 925 has dimensions equal to the inner body 910 to cover the front wall thereof and close the slots 958. In an example, a protrusion 955 extends from the plate 925 and is received in a detent or recess 957 in the center structure so that the plate is fixed to the inner body.

The outer cover 940 is essentially sized the same as the outer body 905 to cover the open front of the outer body 905. A plurality of locking legs 965 extend rearwardly from the main body of the outer cover. In an example, legs 965 are positioned are each corner of the cover 940. The locking legs 965 include caps 970 that are tapered from to rear so that they can be inserted into recesses 975 in the front wall of the outer body 905. Once the caps 970 are inserted into the recesses 975, the legs 965 and, hence the outer cover 940 cannot be removed from the outer body 905.

Assembly of the restraint 900 will not be described. The inner body 910 is slid into the hollow, interior space in the outer body 905 with the inner body slots 952 aligned with the outer body slots 920. The left strap 903 is then folded back toward the center of the coupling 901 such that a loop is above the outer body 905. A portion of the left strap 903 is inserted into the left side slots 920, 952. The handle 933 is positioned beneath the outer body 905. The right side strap 904 is assembled similar to the left side strap but in the right side slots, 920, 952. The plate 925 is connected to the inner body 910 to hold the straps 903, 904 in the respectively slots 920, 952. The cover 940 is then fixed to the outer body 905 such that the straps 903, 904 and inner body 910 cannot be removed from inside the outer body 905.

In operation, an individual's hands are inserted through the loops created by the straps 903, 904. The handles 933, 934 are engaged to draw the straps downwardly through the coupling 901. The inner body 910 moves downwardly to rest on the bottom wall 915 of the outer body 905. The latches or pawls in the inner body allow the straps 903, 904 to move downwardly and do not allow the straps to move upwardly. Accordingly, the loops of the straps 904, 904 become small but cannot become larger. Once tightened on the individual's wrists, the loops cannot become larger to such an extent that an individual can remove their hands back through the loops. The inner body 910 can move within the interior of the outer body without releasing the straps. Accordingly, the strap loops around the individual wrists can loosen slightly, e.g., an eighth to a quarter inch. Accordingly, the chance of overtightening the loops on an individual is reduced.

When the present restraint 900 is used with the system described above with regard to FIGS. 1-8, the coupling 901 is equivalent to the base 442. The end portions of the straps 903, 904 can be engaged by the tightening mechanism, e.g., reels, after the coupling 901. The restraint 900 can further provide the same reduction to the possibility of overtightening when the loops are tightened by a machine.

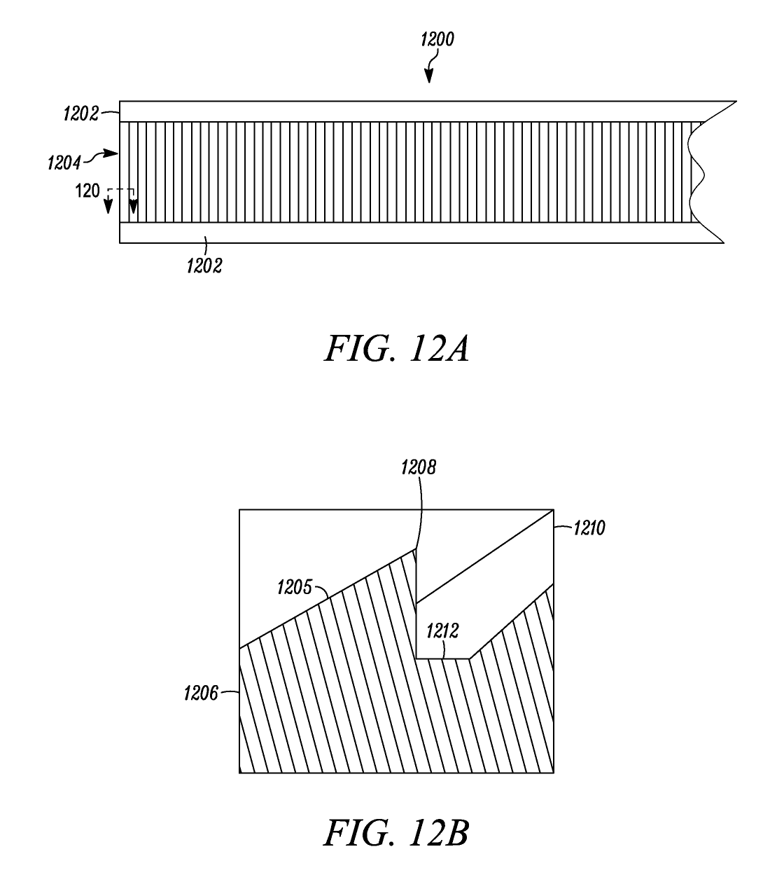

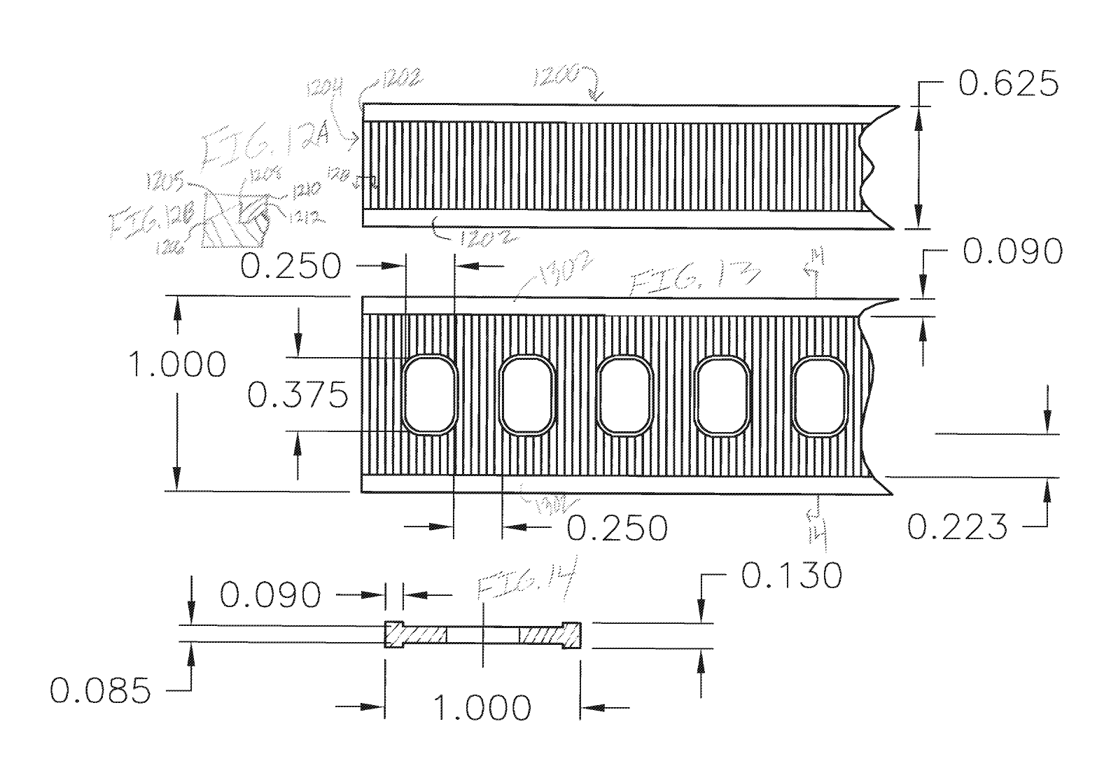

FIGS. 12-14 show various partial views of the straps 1200, 1300 (herein, also designated 903, 904). With reference to FIGS. 12A and 12B, strap 1200 can be made out of nylon or other polymer that has a tensile strength such that a person cannot break the strap. In an example, the strap 1200 has a tensile strength of at least 400 lbs. Strap 1200 has a width in the range of about 0.5 inch to about 0.75 inch. In an example, the width is ⅝^{th} inch. Strap 1200 also includes edges 1202 that are smooth. A ratchet portion 1204 is positioned interior to the edges 1202. The ratchet portion 1204 can include ramp shaped ratchets 1205 that incline from the free end 1206 to a peak 1208, whereat an orthogonal wall 1210 extends down to a base wall 1212. A pawl or other protrusion can move up the ramp to tighten the strap but would not be able to move over the vertical wall 1210 in the reverse direction.

FIG. 13 shows another embodiment of a strap 1300 that includes edge portions 1302 and a center portion 1304 that includes apertures 1310. The center portion 1304 can also include ratchets. Apertures 1310 provide latches that can be engaged by protrusions or other components of a latching system. Strap 1300 can be made out of nylon or other polymer that has a tensile strength such that a person cannot break the strap. In an example, the strap 1300 has a tensile strength of at least 400 lbs. Strap 1300 has a width in the range of about 0.75 inch to about 1.25 inch. In an example, the width is 1.0 inch. The apertures 1310 can be about ⅜^{th} inch by about ¼ inch. FIG. 14 shows a cross sectional view taken generally along line 14-14 in FIG. 13.

In general, restraints that can be used in the present systems comprise two individual engaging parts, linked together by a coupling, which can be rigid. Such a restraint prevents a restrained individual from moving their wrists more than a few centimeters/inches apart or in the case of a rigid coupling, the wrist are bound a few inches/centimeters from each other. This restricts the restrained individual from increasing severity of confrontations, allow the security to evaluate or control a situation and increase the safety of all involved.

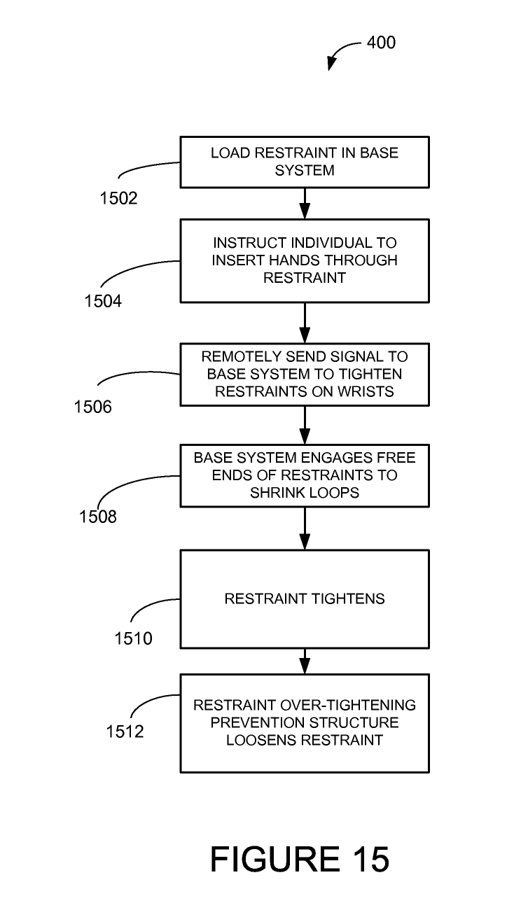

FIG. 15 shows a locking mechanism 1500 for a restraint according to an example. Locking mechanism 1500 engages the ends of the straps that loop around a limb of an individual to fix the loops such that an individual is controlled. In an example, control of an individual is when the individual has restricted movement due to restraints as described herein. Latches 1521, 1522 are provided with pawls that engage ratchets on the straps to hold the straps in place and prevent there their release but allow tightening.

Locking mechanism 1500 can be the center structure 950 as described above. The center structure 950 extends from the rear wall 941 and defines part of the front wall 945. The center structure 950 includes a left side wall 951, a right side wall 952, and a front wall 953. The top and bottom of the center structure 950 are open. The center structure 950 is sized and positioned in another structure such that it can slide in a direction that the straps can move or are inserted into the locking mechanism but do not move laterally. An outer structure around the center structure 950 prevents access to the latches 1510. Open slots 958 are in the front wall of the center structure 950. The slots 958 run the entire height of the center structure and have a width about the same as the width of the strap. In an example, the slot 958 has a width slightly larger than the width of the strap 903, 904. Within the volume defined by the left side wall 952, rear wall 951, and front wall 953, a left latch 1521 is provided. The left latch 1521 can be at least one pawl to engage the ratchet of the strap 903. Within the volume defined by the right side wall 952, rear wall 951, and front wall 953, a right latch 1522 is provided. The right latch 1522 can be a pawl to engage the ratchet of the strap 903. In an example, the left and right latches are mirror images of each other. The latches 1521, 1522 can flex when the strap moves downwardly in the coupling and does not flex if the strap attempts to move upwardly in the coupling. Each of the latches 1521, 1522 can include a solid web from a respective side wall 951, 952 that angles downwardly in the direction of strap insertion into the locking mechanism. The positioning of the web allows the pawls to deflect to such an extent to allow the strap ratchets to move past the latches 1521, 1522 in only one direction. The webs do not allow the ratchets to move past the pawls in the other direction. Accordingly, once the straps are moved in the loop tightening direction, the straps cannot be loosened.

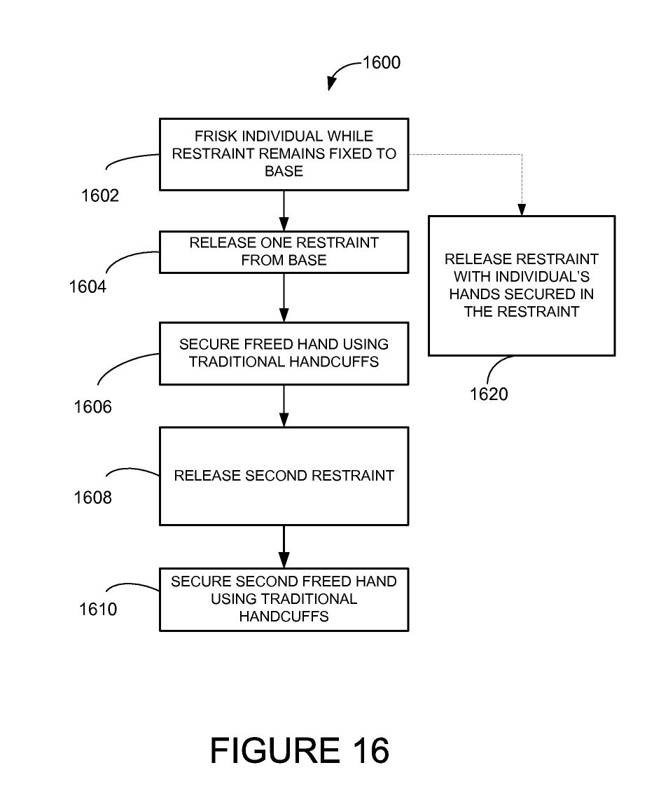

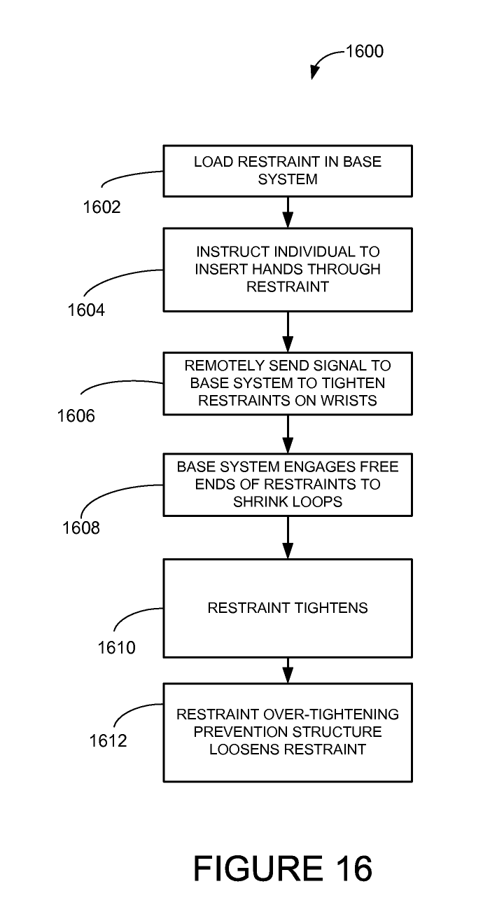

FIG. 16 illustrates a restraint method 1600 according to an embodiment of the present invention. At 1602, the security officer can now approach the restrained individual from behind with the restrained individual faces the restraining device and the vehicle to which the restraining device is fixed. At 1604, the security officer can now, using the remote control device 107 send a signal to the base restraint unit 105 to release one hand, by letting half of the restraint free from the base. In an example, the base and the restraint coupling can release only one of the restraints. At 1606, the security officer can now secure the freed hand of the individual with traditional metal handcuffs while the other hand remains fixed to the restraint, the base restraint unit 105 and the vehicle 102. At 1608, the security officer can now, using the remote control device 107, send a signal to the base restraint unit 105 to release the remaining hand, by letting half of the restraint free from the base. In an example, the base and the restraint coupling can release only one of the restraints. At 1610, the security officer can now secure the newly freed hand of the individual to the other loop on the traditional metal handcuffs while the other hand remains fixed to the traditional metal handcuffs. An optional step, is shown at 1620, whereat the security officer can activate, using the remote control device, release the entire restraint 220, 900

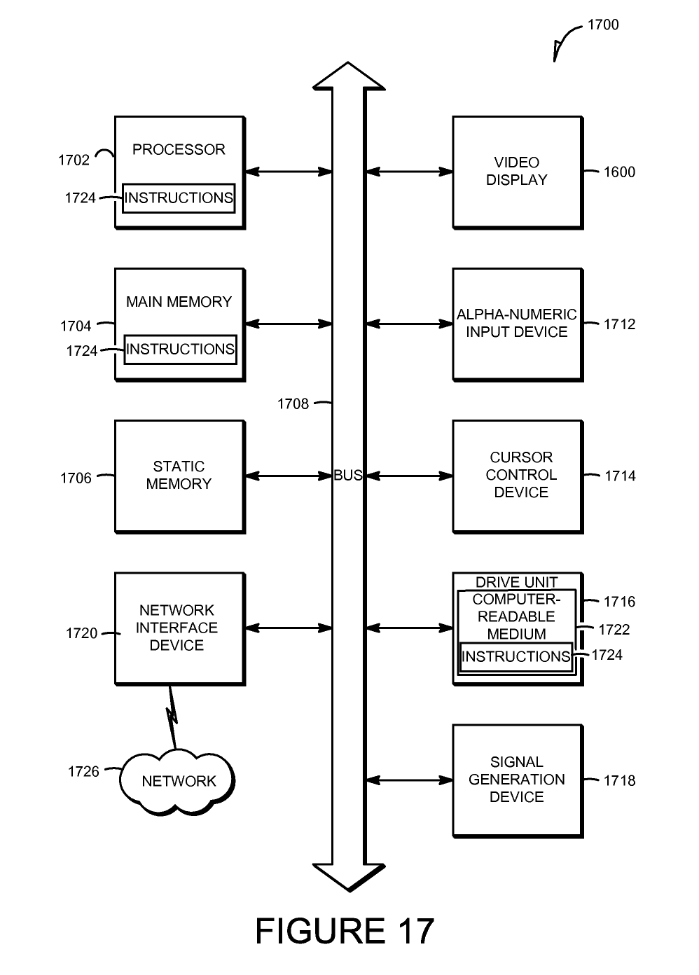

FIG. 17 shows a diagrammatic representation of machine that can be part of the vehicle 102 that the base restraint unit 105 is connected to or part of the remote control unit 107, in the example form of a computer system 1700 within which a set of instructions may be executed causing the machine to perform any one or more of the methods, processes, operations, applications, or methodologies discussed herein. In an example embodiment, the machine operates as a standalone device or may be connected (e.g., networked) to other machines. In a networked deployment, the machine may communicate with a server or a client machine in server-client network environment, or as a peer machine in a peer-to-peer (or distributed) network environment. The machine can include the features and structures of a computer, a personal computer (PC), a tablet PC, a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU) or both), a main memory 1704 and a static memory 1706, which communicate with each other via a bus 1708. The computer system 1700 can further include a video display unit 1710 (e.g., a liquid crystal display (LCD) or a cathode ray tube (CRT)). The computer system 1700 also includes an alphanumeric input device 1712 (e.g., a keyboard), a cursor control device 1714 (e.g., a mouse), a drive unit 1716, a signal generation device 1718 (e.g., a speaker) and a network interface device 1720.

The drive unit 1716 includes a machine-readable medium 1722 on which is stored one or more sets of instructions (e.g., software 1724) embodying any one or more of the methodologies or functions described herein. The software 1724 may also reside, completely or at least partially, within the main memory 1704 and/or within the processor 1702 during execution thereof by the computer system 1700, the main memory 1704 and the processor 1702 also constituting machine-readable media. The software 1724 may further be transmitted or received over a network 1726 via the network interface device 1720.

FIG. 18 illustrates a restraint system 1800 that includes a restraint base unit 105 and a non-flexible restraint 1820. Non-flexible restraint 1820 includes housings 1825, 1826 joined together by a linkage 1827. The linkage 1827 and the housings 1825, 1826 can be made from a resilient material such as a metal, e.g., steel, or a strong polymer. The housings 1825, 1826 conceal a latch/lock mechanism that secures the restraints on an individual's limbs. On each housing, arcuate locking arms 1832, 1833 extend to form a closed loop in the latched position. The locking arms 1832, 1833 can be joined at a pivot 1835. In an example, one of the arms 1832 or 1833 is fixed to the housing. The other of the arms 1833 or 1832 is pivotable at the pivot 1835 to place the restraint in an open position or in a closed, secure position. The pivoting arm 1832 or 1833 includes a pawl to which a latch in housing can engage to fix the restraint securely on an individual's limbs. Restraint base unit 105 is similar to the base units described herein except as otherwise mentioned. That is, the restraint base unit 105 can communicate with the support and a remote. Restraint base unit 105 includes a holster 1840 that receives at least one of the arms 1832, 1833. In the illustrated example, the housing 1825 is also received in the holster 1840. The holster 1840 can be a single, unitary structure that receives both left and right sides of the restraint including the linkage while leaving the openings defined by the arms 1832, 1833 uncovered to receive an individual's limbs. Holster 1840 can be bifurcated into left and right side parts to respectively receive the left or right side handcuff. In an example, the housing 1825 is slightly wider than the arms such that the holster 1840 includes a keyhole that mates with the outline of the restraint. Restraint base unit 105 further includes a tightening mechanism that tightens the handcuffs on the limbs of an individual after the individual inserts their limbs through the loops defined by the arms. In an example, the holster fixes or grips the handcuffs in place. The tightening mechanism can push the lower arm, here labeled as 1833, upwardly so that the loop defined by arms 1832, 1833 contracts to tighten on the individual's limb, e.g., wrist or ankle. The tightening mechanism can include a pusher that is spring loaded to push the arm 1833. The pawls on the arm 1833 are engages by the ratchet in the housing 1825 to lock the handcuff. In another example, the upper arm 1832 is the moveable arm with the pawl. In this example, the restraint base 105 includes an extension that reaches up through the housing to engage the cantilevered end of arm 1832 to pull the arm downwardly into the housing 1825 such that the pawl on arm 1832 engages the ratchet in the housing 1825. The extension releasably grips the arm 1832 such that the extension releases the arm once the pawl and ratchet are engaged to lock the handcuff.

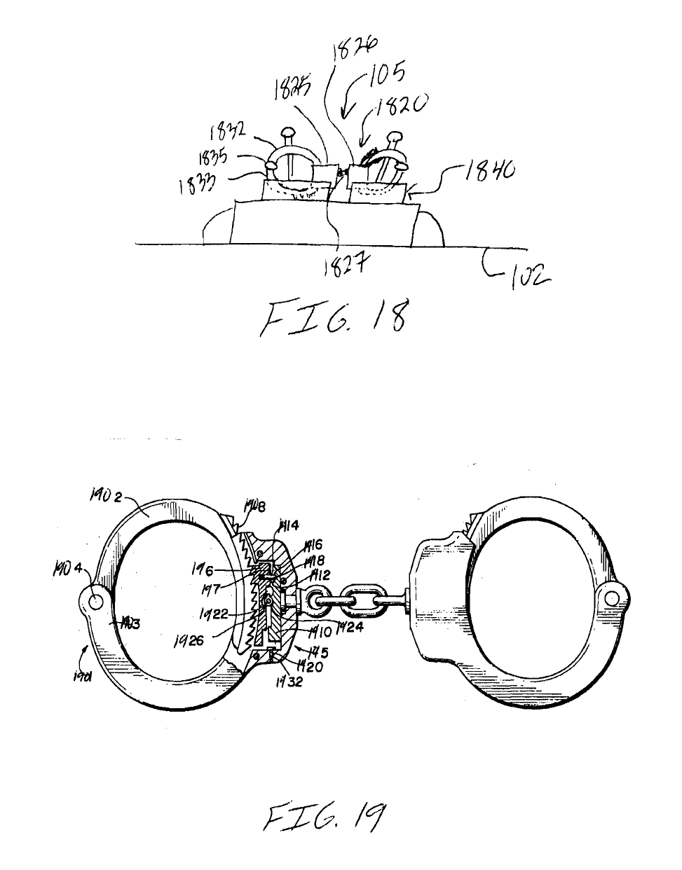

FIG. 19 illustrates a restraint 1900 according to an example of the present invention. The restraint 1900 can be used with the restraint base unit 105 as described herein. Restraint 1900 is shown as a handcuff 1901 that includes arcuate locking arms 1902 and 1903. Arm 1902 is pivoted for rotation at a pivot means 1904. Lock 1905 is secured to one end of arm 1903 and includes pawl 1906 which is formed on the underside of latch member 1907. Ratchet teeth 1908 are disposed on one end of locking arm 1902. Arm 1902 is inserted into lock 1905 whereupon ratchet teeth 1908 cooperate and are locked into pawl 1906 to lock the handcuffs around the wrist of a prisoner or other person. In order to double lock the handcuff 1901, a bolt 1910 is provided. The bolt 1910 includes a shoulder 1912 disposed along one surface thereof. Bolt 1910 is slidable in the lock housing between an unlocked position in which the shoulder does not contact the latch member 1907, and a locked position, which is shown in FIG. 19, in which the shoulder 1912 overlies the latch member 1907. The latch member 1907 is further provided with a detent 1914 for cooperating with two notches 1906 and 1918 in the bolt 1910, and in the undouble-locked position the detent is caught in notch 1916 while in the double-locked position it is caught in notch 1918.

The lock housing includes an aperture 1920. The bolt 1910 is moved from the undouble-locked position to the double-locked position by the security person or by the restraint base unit, who or what can insert the projection on a key end or other “pushing object” into hole 1920 to engage the pusher 1932 to push the bolt 1910 from the undoubled-locked to the double-locked position. A key is inserted into keyhole 1922, then first rotated clockwise to engage ledge 1924 to slide the bolt into the undoable-locked position upon rotation of the key, and the direction of rotation of the key is then reversed to engage ledge 1926 of the latch member to lift the pawl from the ratchet, thereby unlocking the handcuff 1901. In accordance with the present invention, a triple locking arrangement can be provided, wherein the lock is automatically triple locked upon being double locked.

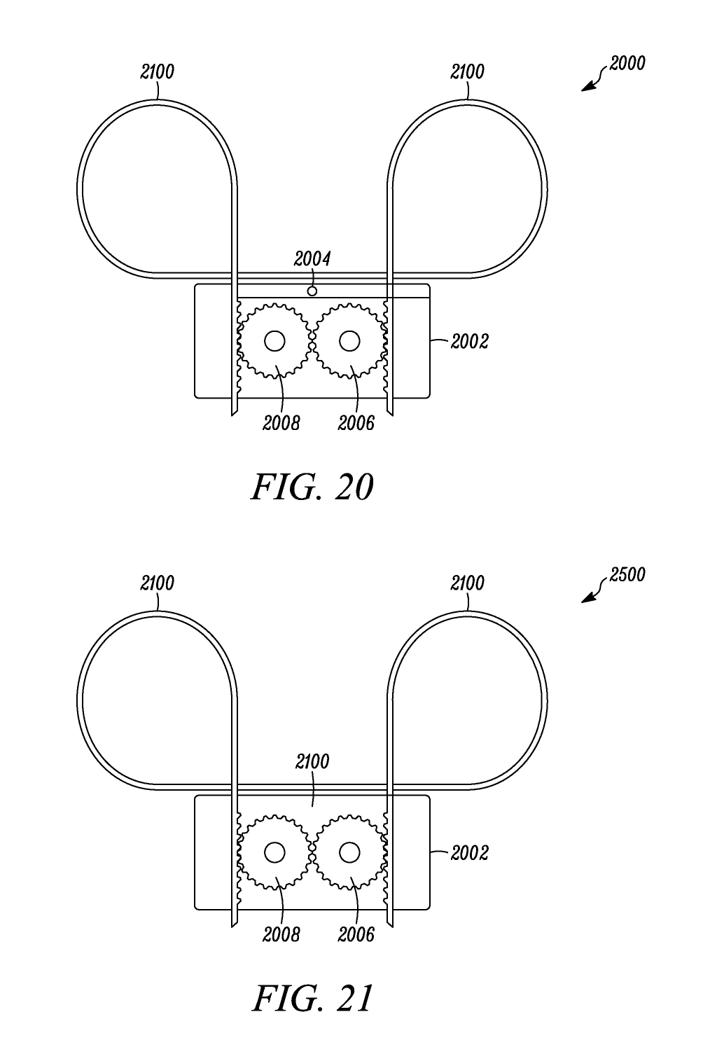

FIGS. 20 and 21 illustrate a restraint system 2000, 2500 utilizing a cable. A metal or fiber cable may be used as a flexible or semi-rigid, re-usable restraint 2100. The cable may be coated with a polymer or fiber coating for comfort or durability, for example. The restraint 2100 includes at least a portion including an engagement mechanism 2008. The engagement mechanism 2008 may be teeth, ridges or other mechanical feature that engages the restraint 2100 and inner binding mechanism 2006. The inner binding mechanism 2006 may be a toothed wheel or wheels, or a mechanical mechanism for contacting the engagement mechanism 2008 such that the cable restraint 2100 may be ratcheted or turned in one direction (i.e., tightening), but not the other without further action (i.e. releasing). As described previously, the binding mechanism 2006 may be controlled remotely and be releasably engaged with the restraint. As shown in FIG. 20, once engaged and tightened in the base 2002, the restraint may be removed from the base 2002. A release mechanism 2004 may then be controlled remotely that releasably engages and disengages under control of a remote device. Alternatively, an entire cartridge assembly (see FIG. 21) may be released from the base 2002 in which the release mechanism is performed by the inner binding mechanism 2006. The release mechanism 2004 may slide or shift in order for teeth to disengage. If the inner binding mechanism is utilized as the release mechanism, they may shift or slide in order to disengage the teeth and loosen the restraint cable 2100.

Various implementations of the subject matter of the method and apparatus described above may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the method and apparatus described above may be implemented on a computer having a display device, such as a touch screen, for displaying information to the user. Other input devices, such as a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The methods and apparatus described and contemplated above may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

While the above description of the operation of the restraint system 100 and at times in particular to restraint unit 105 and restraints 220, addresses restraining the arms of a suspect by attaching restraints to the wrists, it is within the scope of the presently described examples to use the restraints 220 on a suspects ankles as leg shackles.

Flexible restraints can include plastic restraints, also known as wrist ties, riot cuffs, plasticuffs, flexicuffs, flex-cuffs, tri-fold cuffs, zapstraps, or zip-strips. Such flexible restraints could be adapted to be used in the present system 100 as alternate embodiments of restraints. In these example embodiments, the restraints are lightweight and disposable plastic strips. The restraints can be carried in large quantities by security personnel for large scale use, e.g., at large-scale protests and riots. The present drawings further show a double loop restraint that individually secures a limb of a suspect. However, it will be appreciated that the present devices, systems, and methods can be used with a single loop restraint. In an embodiment, a single loop restraint received both limbs, i.e., both arms or both legs, and is tightened to secure the limbs together and allow the security person to control the suspect.

The use of the restraint base and the remote control device allow a security officer to maintain an area of separation from the suspect until the restraint is secured to the suspect.

Although a few variations have been described and illustrated in detail above, it should be understood that other modifications are possible. In addition it should be understood that the logic flow depicted in the accompanying figures and described herein do not require the particular order shown, or sequential order, to achieve desirable results. Other embodiments may be within the scope of the following claims.

1. A restraint system, comprising:
a base including a tightening system;
a restraint loaded into the base, and
a remote to activate the base to apply the restraint to an individual.

2. The restraint system of claim 1, wherein the base includes latching mechanism to securing hold the restraint on the base until a signal to release the restraint is applied to the base.

3. The restraint system of claim 2, wherein the remote sends a release signal to the base and the base releases the restraint, which remains secured to the individual.

4. The restraint system of claim 1, wherein the base is fixed to a support, wherein the base includes a tightening mechanism, and wherein the restraint is a flexible restraint with a free end in the base.

5. The restraint system of claim 4, wherein the base includes reels the engage an end portion of the restraint to tighten a loop around at least one of a wrist or an ankle of an individual.

6. The restraint system of claim 1, wherein the restraint includes a locking mechanism that operates only to tighten and a tightening safety structure to reduce likelihood of overtightening the restraint on an individual.

7. The restraint system of claim 1, wherein the remote includes a wireless transmitter, and the base includes a wireless receiver to communicate with the base.

8. The restraint system of claim 1, wherein the base includes a safety module to prevent restraining an individual to the base when the base is not in a safe mode.

9. The restraint system of claim 1, wherein the safety module includes an accelerometer to sense if the base unit moves to quickly and potentially harm an restrained individual, the accelerometer being coupled to a release mechanism to automatically release the restraint from the base unit if an unsafe acceleration is detected.

10. A restraint, comprising:
a strap to engage a limb of an individual;
a locking mechanism that receives the strap, the locking mechanism including an over-tightening prevention unit.

11. The restraint of claim 10, wherein the over-tightening prevention unit comprises a slidable body in the coupling, the slidable body being moveable after tightening the strap to slacken the strap.

12. The restraint of claim 11, wherein the slidable body is movable by less than half an inch after tightening.

13. The restraint of claim 11, wherein the coupling comprises an inner volume in which the slidable body can move after tightening.

14. The restraint of claim 13, wherein the coupling comprises a first slot to receive the strap, and wherein the slidable body includes a second slot to receive the slot.

15. The restraint of claim 14, wherein the strap includes a ratchet within the slidable body, and wherein the slidable body includes a pawl to engage the ratchet.

16. The restraint of claim 15, wherein the strap includes a first loop and a second loop both extending from the coupling and each having a free end, the free ends are inserted into the coupling and the slidable body.

17. A method of restraining an individual, comprising:
inserting a limb of an individual into a loop defined by a restraint strap;
preventing the loop from tightening if an all-safe signal if not received in a base holding the restraint;
wireless signaling the base to tightening the loop on the limb; and
tightening the loop if not prevented to restrain the individual.

18. The method of claim 17, wherein preventing includes receiving a vehicle in park signal from a vehicle to which the base is fixed.

19.-20. (canceled)

21. The restraint system of claim 1, wherein the restraint comprises a flexible polymer restraint, a rigid metal restraint or a semi-rigid cable.
